(19) United States
(12) Patent Application Publication
(10) Pub. No.: US 2007/0074238 A1
(43) Pub. Date: Mar. 29, 2007

(54) Recording medium cartridge

(75) Inventor: Kiichiro Kitagawa, Kanagawa (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/529,435

(22) Filed: Sep. 29, 2006

(30) Foreign Application Priority Data
Sep. 29, 2005 (JP) P.2005-284875

(51) Int. Cl. G11B 23/03

(52) U.S. Cl. 720/726

(57) ABSTRACT

A recording medium cartridge includes: a photosensitive recording medium having a discoid shape; a main body having: a receiving portion rotatably receiving the photosensitive recording medium therein; and a hollowing portion provided in an outer region of the receiving portion; an inner opening exposing a center and a recording surface of the photosensitive recording medium to an exterior of the main body, the main body having light-shielding properties; a shutter having light-shielding properties, opening and closing the opening of the main body; and a non-contact IC tag provided within the hollowing portion in an outer region of a region covered by the shutter.

### BACKGROUND OF THE INVENTION

1. Field of the Invention

The present invention relates to a cartridge for receiving a photosensitive recording medium in the interior thereof and more particularly to a photosensitive recording medium cartridge which allows the confirmation of the contents of data recorded in the photosensitive recording medium received in the interior thereof.

2. Background Art

Various types of optical discs having various data recorded in a disc-shaped recording medium have been developed. In such an optical disc, it is occasionally practiced to stick a label having a memory column to the outer surface of a casing or the like.

Accordingly, when this memory column is filled up with the contents of data recorded in the optical disc, e.g., individual data such as title, abstract, index and identification number (ID) (hereinafter referred to as “content data”), the content data can be easily confirmed without troubling to reproduce them from the optical disc to advantage. In particular, in the case where many sheets of optical discs are treated, it finds difficulty in searching the optical disc having desired data recorded therein or filing the optical discs by field.

On the other hand, these optical discs occasionally record important confidential data therein. In this case, when the content data are written on the label in the form of letters, there arises a problem that the content data can be read out by anybody besides the user.

In order to facilitate the job of briefly grasping the contents of data in many sheets of optical discs or filing these optical discs by field while preventing these data from being easily read out by other persons, an optical disc with an RFID (radio frequency identification) tag for reading out the content data via electric radiation or induced electromagnetic field has been proposed (see, e.g., JP-A-2001-319380 (the term “JP-A” as used herein means an “unexamined published Japanese patent application”)).

In recent years, a hologram recording medium capable of recording data using hologram has been proposed (see, e.g., JP-A-2004-029476). It has thus been desired to develop a means of allowing the authentic possessor of the hologram recording medium to easily grasp the content data recorded in the hologram recording medium and facilitating the job of briefly grasping the contents of data in many sheets of optical discs or filing these optical discs by field while keeping the system so confidential that the content data cannot be easily grasped by third persons.

### SUMMARY OF THE INVENTION

The invention has been worked out under these circumstances. An object of the invention is to provide a photosensitive recording medium cartridge which allows reading of the content data concerning a photosensitive recording medium and hence easy grasping of the contents of data recording in the photosensitive recording medium while preventing the content data from being easily read by third persons to enhance the confidentiality of data and making it unlikely that the photosensitive recording medium can be exposed to light when the content data is grasped.

The aforementioned object of the invention can be accomplished by the following constitutions:
(1) According to an aspect of the invention, a recording medium cartridge comprising: a photosensitive recording medium having a discoid shape; a main body having: a receiving portion rotatably receiving the photosensitive recording medium therein; and a hollowing portion provided in an outer region of the receiving portion; an inner opening exposing a center and a recording surface of the photosensitive recording medium to an exterior of the main body, the main body having light-shielding properties; a shutter having light-shielding properties, opening and closing the opening of the main body; and a non-contact IC tag provided within the hollowing portion in an outer region of a region covered by the is shutter.

In the cartridge of the invention, a non-contact IC tag is preferably provided on the inner surface of the cartridge main body except the region of the closed position of the shutter. In this arrangement, even when the shutter is at the closed position, the IC tag can be read out.
(2) A recording medium cartridge as described in the item (1), which comprises: a light-shielding plate having an outer opening provided opposite the inner opening of the main body behind the shutter, covering and shielding a outer surface of the main body from light, the outer surface being a region covered by the shutter; and a non-contact IC tag provided in an outer region of a region covered by the light-shielding plate.

In the aforementioned cartridge, the IC tag may be an RFID tag in which data concerning the contents of data recorded in the photosensitive recording medium are stored. In this arrangement, data stored in the memory of RFID tag can be read out in a non-contact mode via induced electromagnetic field or electric radiation to easily grasp the contents of data recorded in the photosensitive recording medium.
(3) The recording medium cartridge as described in the item (1) or (2), wherein the main body has been subjected to one of matting and embossing on an inner surface of the main body opposed to the photosensitive recording medium and the outer surface of the main body opposed to the shutter so that the inner surface and the outer surface of the main body have a surface roughness of from 5 μm to 20 μm.

In this arrangement, even when light beam enters in the interior of the cartridge or the gap between the cartridge main body and the shutter, the roughed surface can diffuse and attenuate the light beam, making it possible to eliminate the effect of light on the photosensitive recording medium.
(4) The recording medium cartridge as described in any one of the items (1) to (3), wherein the main body comprises: a first shell having a sheet shape; and a second shell welded to the first shell in an arrangement superposed on the first shell, the first shell and the second shell comprise same or analogous thermoplastic plastic each other, and other parts including the shutter comprise a material different from the thermoplastic plastic of the first shell and the second shell.

In this arrangement, the first shell and the second shell can be prevented from being welded to the other parts during the welding of the first shell and the second shell to each other.
(5) The recording medium cartridge as described in any one of the items (1) to (4), wherein the first shell, the second shell and the shutter comprise a plastic containing a light-shielding material of 0.01% to 5.00% by weight.
(6) The recording medium cartridge as described in any one of the items (1) to (5), wherein the first shell, the second shell and the shutter comprise a plastic containing a carbon black of 0.01% to 2.00% by weight.

In this arrangement, the light transmittance of the cartridge main body and the shutter can be reduced, making it possible to enhance the light shielding properties of the cartridge.
(7) The recording medium cartridge as described in any one of the items (1) to (6), wherein the first shell, the second shell and the shutter comprise a plastic containing a silicone-based lubricant of 0.1% to 5.0% by weight.

In this arrangement, the shutter can operate smoothly, making it possible to prevent the generation of shavings, etc. due to the friction of the shutter with the cartridge main body.
(8) The recording medium cartridge as described in any one of the items (1) to (7), wherein the photosensitive recording medium is a hologram recording medium.

The aforementioned cartridge can be applied to a hologram recording medium as the photosensitive recording medium. In this arrangement, the hologram recording medium can be carried without being exposed to light and thus can be utilized in recording devices which are installed at different places.

In accordance with the invention, there can be provided a photosensitive recording medium cartridge which allows reading of the content data concerning a photosensitive recording medium and hence easy grasping of the contents of data recording in the photosensitive recording medium while preventing the content data from being easily read by third persons to enhance the confidentiality of data and making it unlikely that the photosensitive recording medium can be exposed to light when the content data is grasped.

### BRIEF DESCRIPTION OF THE DRAWINGS

The invention disclosed herein will be understood better with reference to the following drawings of which:

FIG. 1 is a perspective view illustrating the external shape of a cartridge according to the first embodiment of implementation of the invention;

FIG. 2 is an external perspective view illustrating the cartridge of FIG. 1 with its shutter opened;

FIG. 3 is an exploded perspective view illustrating the configuration of the cartridge of FIG. 1;

FIGS. 4A and 4B depict RFID tag to be mounted on the cartridge of FIG. 1 wherein FIG. 4A is a plan view and FIG. 4B is a configurational block diagram;

FIG. 5 is a perspective view illustrating the external shape of a cartridge according to the second embodiment of implementation of the invention;

FIG. 6 is an external perspective view illustrating the cartridge of FIG. 5 with its shutter opened; and

FIG. 7 is an exploded perspective view illustrating the configuration of the cartridge of FIG. 5.

### DETAILED DESCRIPTION OF THE INVENTION

Embodiments of the cartridge for hologram recording medium according to the invention (hereinafter referred to as “cartridge”) will be described in detail herein in connection with the attached drawings.

(First Embodiment)

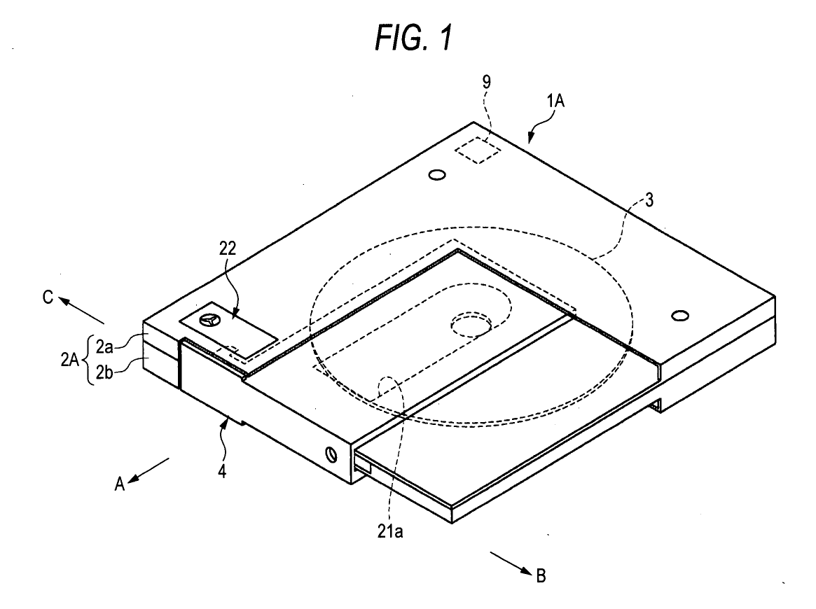

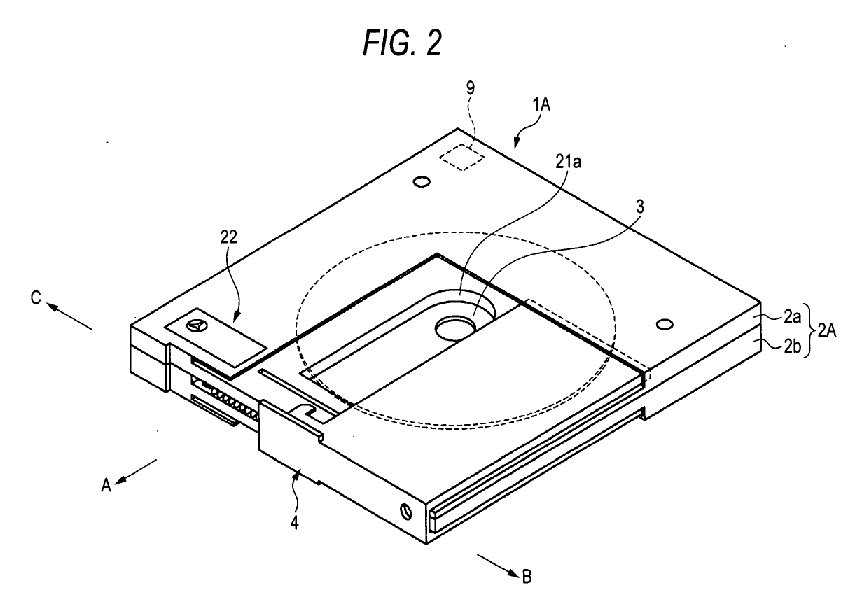

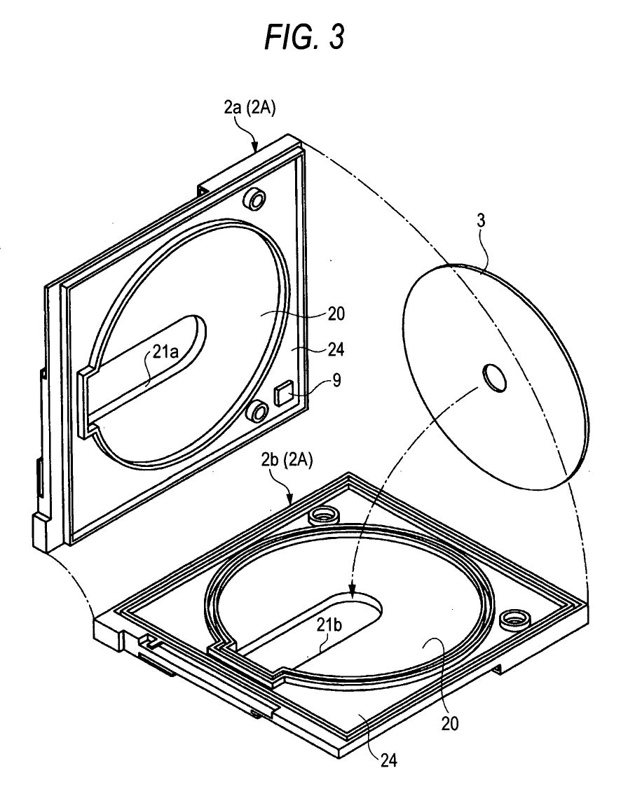

FIG. 1 is an overall perspective view illustrating the external shape of a cartridge 1A as viewed in one direction. FIG. 2 is an overall perspective view illustrating the cartridge 1A of FIG. 1 with a shutter 4 opened. FIG. 3 is a perspective view of essential part of the cartridge 1A with the shutter 4 removed therefrom.

The cartridge 1A comprises a disc-shaped photosensitive recording medium, a cartridge main body 2A (hereinafter referred to as a “cartridge main body”) which received a hologram recording medium 3 (hereinafter referred to as “recording disc”) in the case of the present embodiment and has an opening provided therein for causing a part of the recording disc 3 to be exposed to the exterior, a shutter 4 formed by a light-shielding material for opening and closing the opening of the cartridge main body 2A and an RFID tag 9 provided as an IC tag.

The cartridge main body 2A comprises a substantially sheet-shaped first shell 2a and a substantially sheet-shaped second shell 2b connected to the first shell 2a in such an arrangement that it is superposed on the first shell 2a. The first shell 2a and the second shell 2b each are formed by a light-shielding material which is not a radiation-absorbing material which hinders the reading and writing of RFID tag 9 described later or a radiation-shielding metallic material. In the present embodiment, these shells are each formed by injection-molding a proper thermoplastic material having a light-shielding material and a lubricant incorporated therein.

The first shell 2a and the second shell 2b of the cartridge main body 2A each have substantially tang-shaped openings 21a, 21b provided extending therethrough, respectively, for causing a part of the recording disc 3 received in a receiving portion 20 to be exposed to the exterior.

The cartridge main body 2A has a disc receiving portion (receiving portion) 20 provided interposed between the first shell 2a and the second shell 2b superposed on each other, and a hollowing portion 24 on which the RFID 9 is provided (see FIG. 3). The disc receiving portion 20 has the recording disc 3 rotatably received therein. The recording disc 3 is treated while being received in the interior of the cartridge main body 2A.

The recording disc 3 is a disc having a hole formed in the center thereof and has a hologram recording layer made of a photosensitive material provided on the both surfaces (or one surface) thereof to form a photosensitive recording medium. The hologram recording layers each receive laser beam having a wavelength range of from 532 nm (green) to 405 nm (blue) to make multi-layer recording of data as an interference band of laser beam. The recording disc 3 may be provided with a reinforcement in the hole portion thereof.

The shutter 4 is mounted on the cartridge main body 2A and opens and closes the openings 21a, 21b as previously mentioned. When the shutter 4 is moved in the direction shown by the arrow B in FIG. 2 to the closed position, the openings 21a, 21b are opened. Further, when the shutter 4 is moved in the direction shown by the arrow C in FIG. 1, the openings 21a, 21b are shielded by the shutter 4.

The shutter 4 is kept energized in the direction shown by the arrow C, i.e., in the closing direction by a spring (not shown). The shutter 4 is also locked at the closed position by a locking mechanism 22 formed on the both surfaces of the cartridge main body 2A. In this arrangement, the cartridge 1A prevents the shutter 4 from moving due to vibration or impact on the cartridge main body 2A to open the openings 21a, 21b unnecessarily.

RFID tag 9 is very thin and small-sized and can be disposed anywhere within a distance in which electric wave or induced electromagnetic field acts. Accordingly, in the present embodiment, RFID tag 9 is fixed to the cartridge main body 2A anywhere except the region of opening/closing of the shutter 4 as previously mentioned. In some detail, the RFID tag 9 is fixed to the hollowing portion, that is, the inner surface of the first shell 2a in the vicinity of one corner thereof free of locking mechanism 22, as shown in FIG. 3.

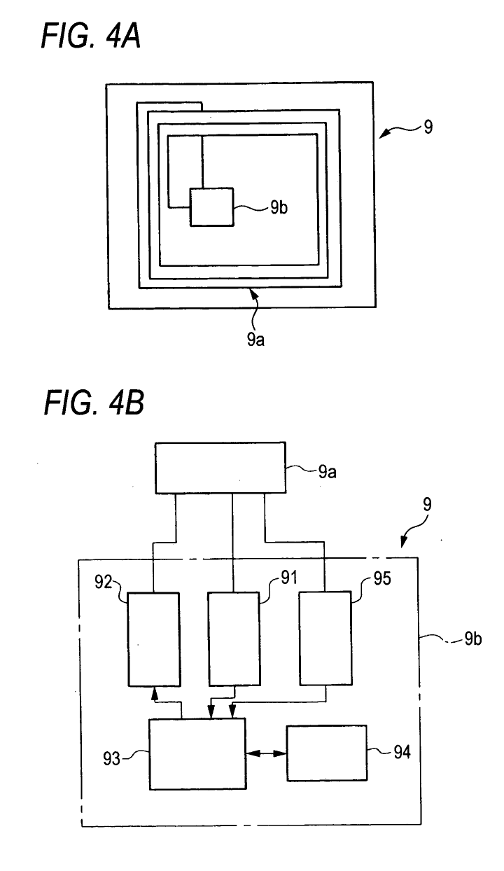

As shown in FIG. 4A, RFID tag 9 comprises an antenna 9a formed by a coil and an IC chip 9b having a memory. RFID tag 9 is arranged such that data which has been stored in a non-contact mode via electric radiation (or induced electromagnetic field) using a tag writer is read out by a tag reader. The antenna 9a and IC chip 9b are mounted on an insulating substrate and clamped by (or molded in) a thin film on the both sides thereof. While the present embodiment has been described with reference to the case where as the antenna of the tag writer or the tag reader there is one disposed at the site opposed to the cartridge slot of the recording device or reproducing device for the recording disc 3, a separate dedicated tag writer or tag reader (e.g., handy type) may be used.

The antenna 9a is in a substantially rectangular or circular form prepared by spirally winding a wire in a plurality of turns. The antenna 9a is connected to the IC chip 9b at the both ends thereof. On the other hand, the IC chip 9b comprises a signal receiving portion 91 having its input connected to the antenna 9a, a signal transmitting portion 92 having its output connected to the antenna 9a, a control portion 93 having its input connected to the output of the signal receiving portion 91 and its output connected to the signal transmitting portion 92, a memory 94 connected to the control portion 93 and a power supply 95 having its input connected to the antenna 9a and its output connected to the input of the control portion 93 as shown in FIG. 4B.

The memory 94 records various data in the recording disc 3 and then stores therein contents of various data recorded in the recording disc 3, e.g., title, index or abstract, even identification number (ID), etc using the tag writer or tag reader. Accordingly, the content data stored in the memory 94, i.e., title, abstract or index, identification number (ID) , etc. of various data recorded in the recording disc 3 can be thereafter displayed on a display portion (not shown) any time using the tag reader or tag (reader) writer. In the present embodiment, the tag reader or tag (reader) writer is attached to the recording device or reproducing device for the recording disc 3. Accordingly, these data are displayed on the display portion provided in this recording device or reproducing device.

The cartridge 1A thus arranged is inserted into the cartridge slot provided in the recording device for recording data in the recording disc 3 or the reproducing device for reading data out of the recording disc 3 in the inserting direction A. When inserted into the recording device or the reproducing device, the cartridge 1A is positioned by the positioning hole provided on the both surfaces of the cartridge main body 2A. When the shutter 3 is moved to the opened position, the openings 21a, 21b are opened.

For example, when the cartridge 1A is inserted into the recording device or reproducing device (not shown) with the shutter 3 shown in FIG. 1 closed, the pickup portion of the recording device or reproducing device is inserted into the cartridge main body 2A through the opening 21a on the first shell 2a disposed on the lower side of the cartridge main body 2A, allowing recording or reproduction of data on the hologram recording layer on the lower side of the recording disc 3.

The recording device or reproducing device a delocking mechanism for delocking the locking mechanism 22 of the cartridge 1A and a shutter opening/closing mechanism for moving the shutter 3 between the closed position and the opened position incorporated in the interior thereof, though both not shown. The delocking mechanism delocks the locking mechanism 22 for the shutter 3. The shutter opening/closing mechanism inserts a driving pin into the inserting hole formed in the shutter 4. The driving pin is then driven in a predetermined direction to move the shutter 4 to the opened position. In this manner, the openings 21a, 21b formed in the respective surface of the cartridge 1A (see FIG. 3 for the opening 21b formed in the both surfaces of the cartridge) are opened as shown in FIG. 2.

The operation of reading out content data stored in RFID tag 9 according to the present embodiment will be described hereinafter. The cartridge is inserted into the recording device or reproducing device with the shutter 3 closed as shown in FIG. 1 and upside down. In this arrangement, transmission and reception of electric radiation having a specific frequency (e.g., 13.56 MHz) is effected between the transmission/reception antenna for tag reader additionally provided opposed to the cartridge slot of the recording device or reproducing device (not shown) and the antenna 9a of RFID tag 9 provided on the inner surface of the first shell 2a provided opposed to the transmission/reception antenna. In this manner, the tag reader can read out the content data stored in the memory 94 of RFID tag 9 (e.g., title, index or abstract, even identification number (ID), etc. of data recorded in the recording disc 3) and then display them on the display portion of the recording device or reproducing device for the recording disc 3, making it easy to grasp the content data.

(Second Embodiment)

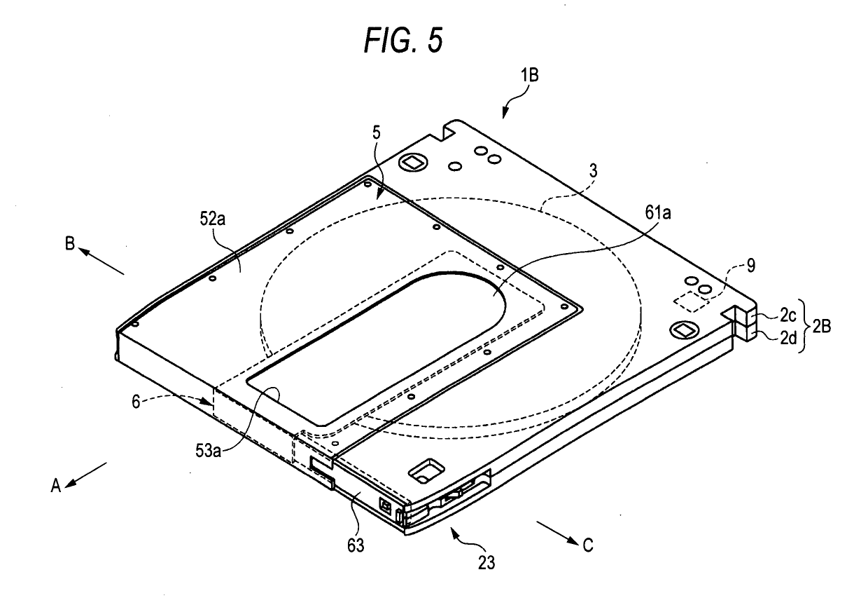

The second embodiment of implementation of the invention will be described in connection with FIGS. 5 to 7. In the present embodiment, the same parts as those of FIG. 1 are given the same reference numeral and arc not described again.

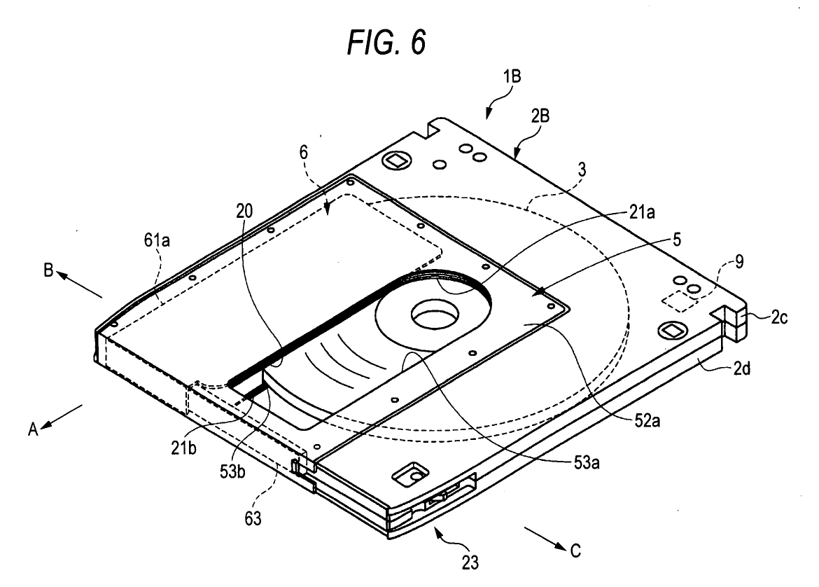

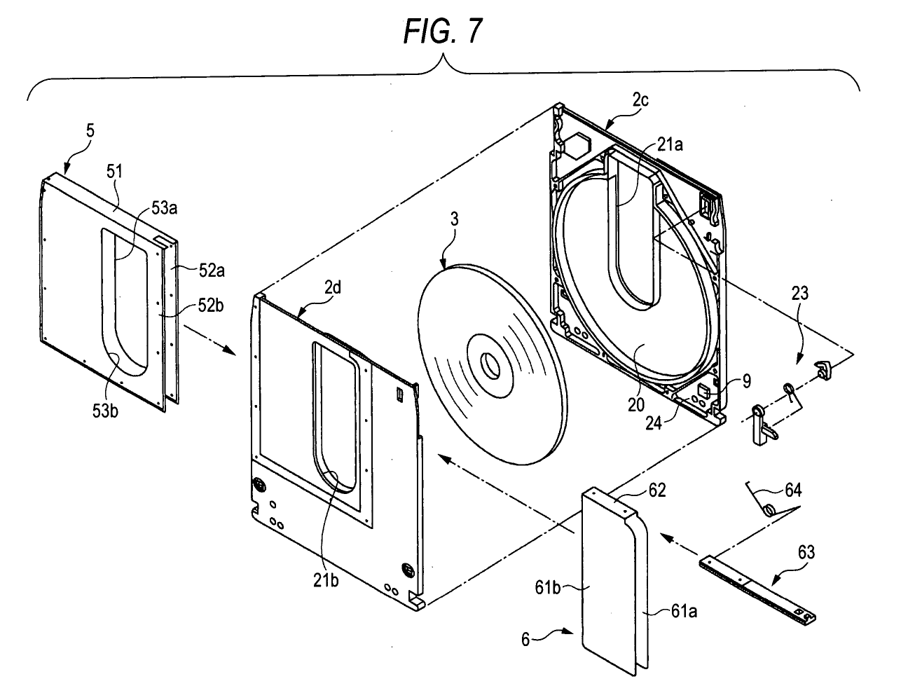

FIGS. 5 to 7 are a perspective view, an exploded perspective view and a transverse sectional view illustrating the external shape of a cartridge 1B according to the present embodiment, respectively. In some detail, FIG. 5 is a perspective view of the cartridge 1B with its shutter 6 closed. FIG. 6 is a perspective view of the cartridge 1B with its shutter 6 opened. FIG. 7 is an exploded perspective view illustrating a cartridge main body 2B, a light-shielding plate 5, a shutter 6 and a recording disc 3 received in the interior of the cartridge main body 2B constituting the cartridge 1B.

The cartridge 1B according to the present embodiment comprises the cartridge main body 2B having a disc receiving portion 20 (see FIG. 7) provided therein for receiving the recording disc 3 therein, the light-shielding plate 5 mounted with the outer side of the cartridge main body 2B interposed therebetween, the shutter 6 incorporated interposed between the cartridge main body 2B and the light-shielding plate 5 and RFID tag 9 mounted on the cartridge main body 2B. The cartridge 1B, too, is inserted into the cartridge slot provided in the recording device for recording data in the recording disc 3 or the reproducing device for reading out data from the recording disc 3 in the inserting direction A.

In the cartridge 1B, the locking mechanism 23 is delocked by the delocking mechanism of the recording device or reproducing device (not shown). At the same time, the shutter 6 is moved to the opened position by the sliding mechanism of the recording device or reproducing device (for moving the shutter 6 between the closed position and the opened position) so that the openings 21a, 21b and the external openings 53a, 53b described later are opened.

The cartridge main body 2B, the light-shielding plate 5 and the shutter 6 will be further described hereinafter.
(I) Concerning the Cartridge Main Body 2B

The cartridge main body 2B comprises a substantially sheet-shaped first shell 2c and a substantially sheet-shaped second shell 2d connected to the first shell 2c in such an arrangement that it is superposed on the second shell 2d. In the inner space between the first shell 2c and the second shell 2d is provided a disc receiving portion 20 and a hollowing portion 24 (see FIG. 3) similarly to the first embodiment. The first shell 2c and the second shell 2d each are formed by injection-molding a light-shielding material which is not a radiation-absorbing material which hinders the reading and writing of RFID tag 9 or a radiation-shielding metallic material, such as proper thermoplastic plastic material having a light-shielding material and a lubricant incorporated therein, similarly to the first embodiment.

The first and second shells 2c, 2d have substantially tang-shaped openings 21a, 21b, respectively, provided extending therethrough as first opening for causing a part of the recording disc 3 received in the disc receiving portion 20 to be exposed to the exterior similarly to the first embodiment. The first and second shells 2c, 2d each have a light-shielding plate 5 provided on the outer surface thereof as shown in FIG. 7. In a slide chamber defined by the light-shielding plate 5 and the outer surface of the first and second shells 2c, 2d is provided slidably the shutter 6.

In the present embodiment, RFID tag 9 is fixed to the cartridge main body 2B anywhere except the region of disposition of the light-shielding plate 5. In some detail, RFID tag 9 is fixed to the hollowing portion 24 in the vicinity of one corner thereof free of locking mechanism 23.
(II) Concerning Light-Shielding Plate 5

On the other hand, the light-shielding plate 5 forms a space between a sheet-shaped guide portion 51 disposed in contact with the inserting surface of the cartridge main body 25 (forward end surface in the inserting direction A) and the outer surface of the cartridge main body 2B as shown in FIG. 7. In the space are provided substantially light-shielding portions 52a, 52b constituting the slide chamber that slidably receives the shutter 6 therein.

The light-shielding portions 52a, 52b of the light-shielding plate 5 have substantially tang-shaped external openings 53a, 53b formed therein in the site thereof opposed to the substantially tang-shaped first openings 21a, 21b of the cartridge main body 2B, respectively, as a second opening for causing the center and the recording surface of the recording disc 3 to be exposed to the exterior when the shutter is in the opened position described later. When the external openings 53a, 53b are closed by the movement of the shutter 6 in the slide chamber to the closed position, the disc receiving portion 20 of the cartridge main body 2B is shielded from light and becomes dustproof, making it possible to keep the recording disc 3 clean without being exposed to light.

While the light-shielding plate 5 is formed by a proper light-shielding metallic material, the invention is not limited thereto. As the light-shielding material which is not a radiation-absorbing material which hinders the reading and writing of RFID tag 9 or a radiation-shielding metallic material, i.e., light and rigid material which can be provided with light-shielding properties, corrosion resistance, decoratability and workability there may be used a proper plastic material. In this case, the light-shielding plate 5, too, is preferably made of a plastic material having a lubricant incorporated therein to assure good slipperiness with respect to the shutter 6.
(III) Concerning Shutter 6

The shutter 6 has an external shape which is the same as or greater than the opening 21a of the first shell 2c and the external opening 53a of the light-shielding plate 5 and has shutter portions 61a, 61b having light-shielding properties and a thin plate-like sliding portion 62 attached to one surface (upper end as viewed on FIG. 7) of the shutter portions 61a, 61b provided slidably in the slide chamber of the light-shielding plate 5. The shutter 6 also comprises a connecting member 63 to be connected thereto when the shutter 6 is caused to slide by the sliding mechanism provided in the reading device or reproducing device and a shutter spring 64.

The shutter 6 is disposed insuch an arrangement that it slides between the “closed position” at which the opening 21a as first opening of the cartridge main body 2B is closed and the “opened position” as which the opening 21a as first opening of the cartridge main body 2B is opened, is kept energized toward the positioned position by the shutter spring 64 incorporated therein and is locked at the closed position by the locking mechanism 23 of the cartridge main body 2B. In this arrangement, the shutter 6 can be prevented from being unnecessarily opened.

The shutter 6, too, is formed by a light-shielding metallic material. The shutter 6 may be also formed by a light-shielding material which is not a radiation-absorbing material which hinders the reading and writing of RFID tag 9 or a radiation-shielding metallic material, i.e., light and rigid material which can be provided with light-shielding properties, corrosion resistance, decoratability and workability, e.g., proper plastic material for the same reasons as for the light-shielding plate 5. In this case, the shutter 6 is preferably made of a material having a lubricant incorporated therein to assure good slipperiness with respect to the light-shielding plate 5 and the cartridge main body 2B.

The connecting member 63 is a substantially slender sheet and has a sliding portion 62 connected to one end thereof. The connecting member 62 is also arranged such that the other end thereof can be connected to the sliding mechanism provided in the recording device or reproducing device (not shown). In this arrangement, after the delocking of the locking mechanism 23 of the cartridge main body 2B by the delocking mechanism provided in the recording device or reproducing device, the connecting member 63 is pressed by the driving force of the sliding mechanism to slide in the opening direction B against the spring force of the shutter spring 64. In this manner, the shutter portions 61a, 61b of the shutter 6 can move to the opened position in the slide chamber of the light-shielding plate 5 via the sliding portion 62 connected to the connecting member 63.

The connecting member 63 has a groove (not shown) formed therein along the longitudinal direction. Into the groove are inserted a raised portion provided on the inner surface of the forward end of the first shell 2c and the second shell 2d in the inserting direction. The provision of the groove and the raised portions makes it possible for the connecting member 63 to slide without slipping off the cartridge main body 2B.

The shutter spring 64 uses its elastic force to keep the shutter 6 energized in the closing direction C. The shutter spring 64 is made of a torsion spring (or coil spring or substantially V-shaped thin leaf spring) and is attached to the inner surface of the first shell 2c at one end thereof and to the connecting member 63 (or the shutter 6) at the other. In this arrangement, the shutter 6 is normally kept disposed at the closed position by the elastic force of the shutter 64 when neither reading nor recording is effected.

The operation of reading out content data stored in RFID tag 9 according to the present embodiment will be described hereinafter. The cartridge is inserted into the recording device or reproducing device with the shutter 3 closed as shown in FIG. 5 and upside down. In this arrangement, transmission and reception of electric radiation having a specific frequency (e.g., 13.56 MHz) is effected between the transmission/reception antenna for tag reader additionally provided opposed to the cartridge slot of the recording device or reproducing device (not shown) and the antenna 9a of RFID tag 9 provided on the inner surface of the first shell 2c provided opposed to the transmission/reception antenna. In this manner, the tag reader can read out the content data stored in the memory 94 of RFID tag 9 (e.g., title, index or abstract, even identification number (ID), etc. of data recorded in the recording disc 3) and then display them on the display portion of the recording device or reproducing device for the recording disc 3, making it easy to grasp the content data.

The invention is not limited to the aforementioned embodiments. Various changes and improvements can be made in the invention. While all the embodiments have been described with reference to a cartridge for receiving a hologram recording medium, the invention can be applied also to a cartridge for receiving other photosensitive recording media.

The cartridge of the invention allows the user or the like to easily read out the content data stored in IC tag using a handy type tag reader while disabling third persons from reading out the content data unless the tag reader or the like is available, making it possible for the user to not only readily grasp the contents of data recorded in the photosensitive recording medium but also prevent the contents of data recorded in the photosensitive recording medium from being grasped by third persons. Thus, the cartridge of the invention has a high confidentiality.

### EXAMPLE

An example of the invention will be described hereinafter. As the thermoplastic resin to be used in the formation of the upper shell and the lower shell there may be used PBT, ABS, POM, PS, PP, HDPE, PA, PET, PPS, SAN (styrene-acrylonitrile copolymer), PMMA, PC or the like. In order to prevent erroneous welding during supersonic welding, as the material constituting the upper shell and the lower shell there is preferably used a material different from that of the upper shell and the lower shell selected from the group consisting of the aforementioned thermoplastic resins.

As the material of the upper shell and the lower shell there is used a plastic which exhibits a visible light transmittance of not greater than 1.0% at a thickness of 0.2 mm. In order to obtain a necessary physical strength, the first shell 44 and the second shell 46 each are preferably formed to a thickness of from 0.2 mm to 1.6 mm. In order to obtain a plastic having the aforementioned light-shielding properties, a light-shielding material is preferably added. As the light-shielding material there may be used any of various light-shielding materials. The light-shielding material is preferably incorporated in an amount of from 0.01% to 5.00% by weight depending on the kind thereof. Proposed examples of the light-shielding material will be given below.
(1) Inorganic Compounds

A. Oxide: silica, diatomaceous earth, alumina, titanium oxide, iron oxide (black iron oxide), zinc oxide, magnesium oxide, antimony oxide, barium ferrite, strontium ferrite, beryllium oxide, pumice stone, pumice stone balloon, alumina fiber, etc.

B. Hydroxide: aluminum hydroxide, magnesium hydroxide, basic magnesium carbonate, etc.

C. Carbonate: calcium carbonate, magnesium carbonate, dolomite, dawsonite, etc.

D. Sulfate (sulfite): calcium sulfate, barium sulfate, ammonium sulfate, calcium sulfite, etc.

E: Silicate: talc, clay, mica, asbestos, glass fiber, glass balloon, glass bead, calcium silicate, montmorillonite, bentonite, etc.

F: Carbon: carbon black, graphite, carbon fiber, carbon hollow sphere, etc

G: Others: iron powder, copper powder, aluminum powder, molybdenum sulfide, boron fiber, silicon carbide fiber, brass fiber, potassium titanate, lead titanozirconate, zinc borate, barium metaborate, calcium borate, sodium borate, aluminum paste, talc, etc.
(2) Organic Compound

Wood powder (pine, oak, sawdust, etc.), grain fiber (almond, peanut, chaff, etc.), cotton, jute, paper piece, non-wood fiber (straw, kenaf, bamboo, esparto, pagas, mulukhiyya (jew's mallow), soot, etc.), cellophane piece, nylon fiber, polypropylene fiber, starch (including modified starch, surface-treated starch), aromatic polyamide fiber, etc.

Preferred among these light-shielding materials are inorganic compounds which have no adverse effects on photographic properties and stay thermally stable and opaque even at a temperature as high as 150° C. or more, particularly preferably carbon black, titanium nitride, graphite and black ion oxide, which are relatively inert light-absorbing materials having excellent heat resistance and light-resistance.

The added amount of carbon black, if used as a light-shielding material, is preferably from 0.01% to 2.00% by weight because a plastic having well-balanced light-shielding properties and physical strength can be obtained as mentioned above.

Examples of the classification of carbon black materials include gas black, furnace black, channel black, anthracene black, acetylene black, ketjen carbon black, thermal black, lamp black, lamp soot, soot of burnt pine, animal black, and vegetable black.

Preferred examples of commercially available carbon black products include Carbon Black #20(B), #30(B), #33(B), #40(B), #41(B), #44(B), #45(B), #50, #55, #100, #600, #950, #1000, #2000(B), #2400(B), MA8, MA11, and MA100. Further examples of commercially available carbon black products include various grade products such as Denka Black (produced by DENKI KAGAKU KOGYO KABUSHIKI KAISHA), SEAST (produced by Tokai Carbon Co., Ltd.), Asahi #78 (produced by Asahi Carbon Co., Ltd.), Showa Black (produced by Showa Cabot Co., Ltd.), NITERON (produced by Nippon Steel Chemical Carbon) and Diablack (produced by Mitsubishi Chemical Corporation).

Examples of overseas carbon black products include Black Pearls 2, 46, 70, 71, 74, 80, 81 and 607, Regal 1300, 330, 400, 660, 991 and SRF-S, Vulcan 3 and 6 and Sterling 10, SO, V, S, FT-FF and MT-FF (produced by Cabot Co., Ltd.).

Further examples of overseas carbon black products include United R, BB, 15, 102, 3001, 3004, 3006, 3007, 3008, 3009, 3011, 3012, XC-3016, and XC-3017 and 3020 (produced by Ashland Chemical Company). However, the invention is not limited to these products.

As the lubricant to be incorporated in the upper shell and the lower shell there may be used a silicone-based lubricant, particularly various grade dimethyl polysiloxanes. Various grade products commercially available from Dow Corning Toray Co., Ltd., Toray Silicone Co., Ltd., GE Toshiba Silicone Co., Ltd., WACKER ASAHIKASEI SILICONE Co., LTD., Shin-Etsu Chemical Co., Ltd., etc. may be used. The lubricant may be used in the form of either master batch or kneaded product. The amount of the silicone-based lubricant to be incorporated is preferably from 0.1% to 5.0% by weight because a plastic having well-balanced frictional resistance, producibility and product quality can be obtained as mentioned above.

Referring to the roughened surface provided on these shells, when the surface roughness Ra is not greater than 5 μm, the resulting light diffusing effect is insufficient. When the surface roughness Ra is not smaller than 20 μm, these shells can scratch the hologram recording medium 200 when they come in contact with the hologram recording medium 200. Therefore, the first and second shells 44, 46 each are preferably subjected to matting for surface roughness Ra of from 5 μm to 20 μm or embossing.

While the present example has been described with reference to the case where the fixing of the upper shell and the lower shell to each other is carried out by supersonic welding, other welding methods and fixing methods may be used. In the case where fixing is made by screwing, for example, the light-shielding structure is preferably formed also in the periphery of the threaded hole.

The present application claims foreign priority based on Japanese Patent Application (JP 2005-284875) filed Sep. 29 of 2005, the contents of which is incorporated herein by reference.

What is claimed is:

1. A recording medium cartridge comprising:
a photosensitive recording medium having a discoid shape;
a main body having:
a receiving portion rotatably receiving the photosensitive recording medium therein; and
a hollowing portion provided in an outer region of the receiving portion;
an inner opening exposing a center and a recording surface of the photosensitive recording medium to an exterior of the main body, the main body having light-shielding properties;
a shutter having light-shielding properties, opening and closing the opening of the main body; and
a non-contact IC tag provided within the hollowing portion in an outer region of a region covered by the shutter.

2. A recording medium cartridge as claimed in claim 1, which comprises:
a light-shielding plate having an outer opening provided opposite the inner opening of the main body behind the shutter, covering and shielding a outer surface of the main body from light, the outer surface being a region covered by the shutter; and
a non-contact IC tag provided in an outer region of a region covered by the light-shielding plate.

3. The recording medium cartridge as claimed in claim 1, wherein the main body has been subjected to one of matting and embossing on an inner surface of the main body opposed to the photosensitive recording medium and the outer surface of the main body opposed to the shutter so that the inner surface and the outer surface of the main body have a surface roughness of from 5 μm to 20 μm.

4. The recording medium cartridge as claimed in claim 1, wherein the main body comprises:
a first shell having a sheet shape; and
a second shell welded to the first shell in an arrangement superposed on the first shell,
the first shell and the second shell comprise same or analogous thermoplastic plastic each other, and
other parts including the shutter comprise a material different from the thermoplastic plastic of the first shell and the second shell.

5. The recording medium cartridge as claimed in claim 1, wherein the first shell, the second shell and the shutter comprise a plastic containing a light-shielding material of 0.01% to 5.00% by weight.

6. The recording medium cartridge as claimed in claim 1, wherein the first shell, the second shell and the shutter comprise a plastic containing a carbon black of 0.01% to 2.00% by weight.

7. The recording medium cartridge as claimed in claim 1, wherein the first shell, the second shell and the shutter comprise a plastic containing a silicone-based lubricant of 0.1% to 5.0% by weight.

8. The recording medium cartridge as claimed in claim 1, wherein the photosensitive recording medium is a hologram recording medium.
